(19) United States
(12) Patent Application Publication
(10) Pub. No.: US 2021/0056835 A1
(43) Pub. Date: Feb. 25, 2021

(54) SHUTTER TEST DEVICE FOR FLAME/FIRE DETECTORS

(71) Applicant: Nero Endustri Savunma Sanayi Anonim Sirketi, Istanbul (TR)

(72) Inventor: Alican OKCUN, Ankara (TR)

(21) Appl. No.: 16/712,139

(22) Filed: Dec. 12, 2019

(30) Foreign Application Priority Data
Aug. 21, 2019 (TR) 2019/12530

(51) Int. Cl. G08B 29/14; F23M 11/04; G08B 17/107

(52) U.S. Cl. CPC G08B 29/145; G08B 17/107; F23M 11/045

(57) ABSTRACT

A shutter test device is provided for determining whether or not detectors detecting flame spectrum at UV and IR wave lengths by forming virtual flame/fire spectrum work, and estimating detection time per milliseconds, estimating the time period in which tubes explode, as well as the time period in which the fire extinguishing system works. The shutter provides or prevents delivery of light source radiations to the detector under control of the control unit. The control unit receives alarm signal generated by detectors detecting sent radiation via cable or wireless estimates response time activated as a result of alarm signal and tests working of the fire extinguishing system subject to said alarm, and the activation period, and calculates the time period of activation.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The invention relates to a shutter test device for determining whether or not detectors forming virtual flame/fire spectrum and detecting a flame spectrum at UV and IR wave lengths work, and estimating detection time per mil seconds, estimating the time period in which tubes explode, as well as the total time period in which system becomes active.

### 2. Description of Related Art Including Information Disclosed Under 37 CFR 1.97 and 37 CFR 1.98

In the prior art, UV and IR light sources are integrated into a test lamp and used for testing UV/IR sensors. However, it is almost impossible to estimate the time period in which the detectors react to said light sources and, the time period in which tubes discharged actively after warning, and in general the time period in which the system becomes active. In addition, it is required to use a shutter test device/lamp which is not portable and integrating to a system and needing intermediate components to measure the cases.

U.S. Pat. No. 4,529,881A relates to a flame detector comprising an adjustable view angle and test lamp. The flame detector comprises a housing, an observation window located in the house and a sensor located in a manner to view outside area from observation window. In addition, it comprises a test lamp performing test simulation of the detector in said housing. As described above, test lamp is used in a form wherein it is integrated into flame detector. For that reason, it is mostly impossible to obtain efficient measurement data. On the other hand, no shutter or equivalent component to control radiation of light sources is mentioned.

In the related art, the application numbered WO206125936A1 relates to a flame detector comprising a test source for electromagnetic radiation. Said test source and related sensor are in a housing inside a detector. The source is located in a manner to radiate in line with the sensor and thus tests for flame can be made without need for any outer test source. However, such embodiment is not able to estimate alarm and activation times and does not mention an embodiment like a shutter etc. to help it.

As a result, due to above described disadvantages and inadequacy of existing solutions, it has been necessary to make development in the related art.

### BRIEF SUMMARY OF THE INVENTION

The main purposes of the invention are to determine whether or not detectors detecting flame spectrum formed in UV and IR wave lengths by forming virtual flame/fire spectrum work, and to determine how many milliseconds it takes to conduct detection, as well as the time period in which tubes explode. Required tests of detectors used for flame/fire detection systems and their tubes are conducted.

Contrary to test lamps in the related art, a portable device is hereby disclosed. Preferably, with a test lamp operated by a 24V external power supply the time in which reaction to radiation after opening of shutter can be measured by data displayed on a screen such as an LCD for UV and IR sources located behind a shutter thanks to its mechanical and software features as a result of radiation made towards the sensors.

On the other hand, due to the start button of the test lamp, both electric line of lamp and shutter system is supplied. Thus, the time of opening of the shutter is taken as t0 time and the time in milliseconds in which detectors run is tested without need for an extra installation.

The structural and characteristic features and all advantages of the invention will be understood better in the figures given below and the detailed description by reference to the figures. Therefore, the assessment should be made based on the figures and considering the detailed descriptions.

### BRIEF DESCRIPTION OF THE SEVERAL VIEWS OF THE DRAWINGS

FIG. 1 is an exploded view of the test device of the invention.

FIG. 2 is a perspective view of the test device of the invention in mounted form.

FIG. 3 is front and profile view of test device of the invention.

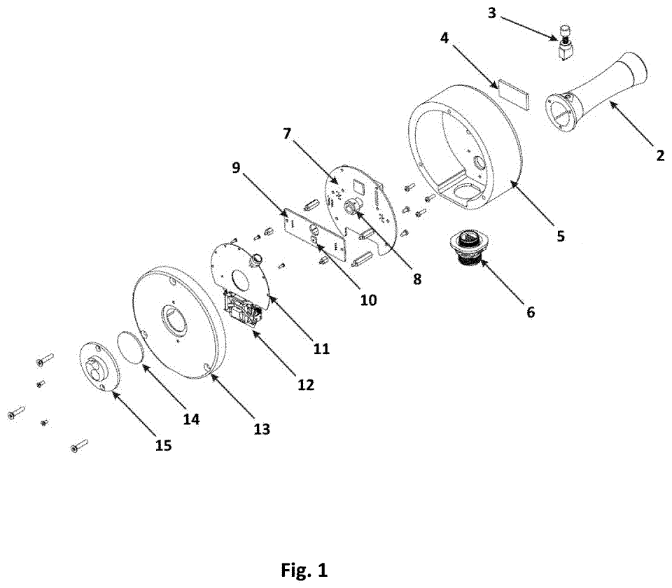

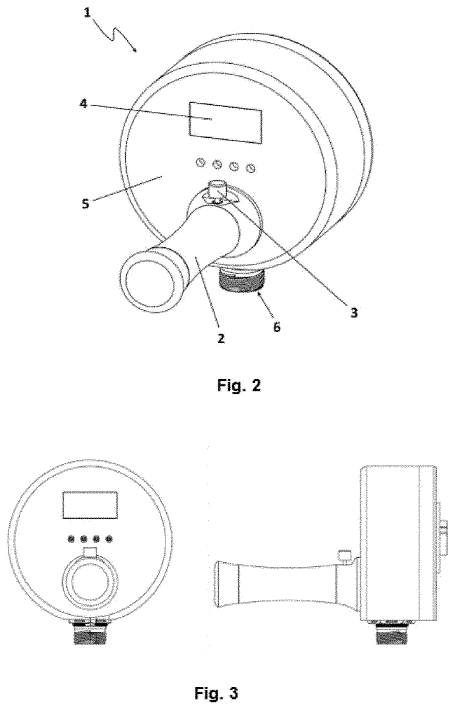

The drawings are not necessarily scaled and the details not necessary for understanding the present invention might have been neglected. In addition, the components which are equivalent to a great extent at least or have equivalent functions at least have been assigned the same number.

### DESCRIPTION OF PART REFERENCES

1. Test device
2. Handle
3. Triggering mechanism
4. Screen
5. Device box
6. Connection member
7. Alarm detection and measurement circuit
8. IR light source
9. UV light source card
10. UV light source
11. Shutter
12. Shutter driver circuit
13. Front Lid
14. Glass
15. Lock

### DETAILED DESCRIPTION OF THE INVENTION

In this detailed description, the preferred embodiments of the invention have been described in a manner not forming any restrictive effect and only for purpose of better understanding of the matter.

The test device (1) of the invention controls whether or not detectors detecting flame spectrum generating at UV (ultraviolet) and IR (Infrared) wavelengths work, as well as estimates the time period in which tubes become active and total system activation as a consequence thereof and comprises following components:
IR and/or UV light sources making radiation at different wavelengths that can be detected by sensors in the detectors to be tested and having flame spectrum;
a shutter (11) located in front part of light sources, which controls reach of radiations of light sources to detectors by opening and closing;
a unit receiving alarm signal generated by detectors perceiving sent rays, determining response time period of fire tubes activated as a result of alarm signal, calculating total system (detector and tube) activation time subject to said alarm and activation periods;
a triggering mechanism (3) of button etc. activating/deactivating control unit, bringing shutter (11) to open/close position.

In an embodiment of the invention, a screen (4) located on device box (5) receives data obtained in the control unit and displays to the user.

In a preferred embodiment of the invention, IR light source (8) and/or UV light source (10) is used as light source. Said light sources are located on IR light source card and UV light source card (9) and driven by said cards.

In a preferred embodiment of the invention, the control unit comprises shutter driver circuit (12) in device box (5). Triggering mechanism (3) which is a button located on preferably handle (2) controls shutter (11) by means of shutter driver circuit (12) when alerted. Lock (15) located in front section of front lid (13) fixes light sources to device box (5). The device box (5) is made from fireproof material and thus protects components provided therein against fire and external factors.

In a preferred embodiment of the invention, said control unit also comprises an alarm detection and measurement circuit (7). The circuit (7) determines the time period in which detector detects radiations transmitted from IR and UV sources (8, 10) and reaching it and gives alarm by means of signals given by wire connection and/or wireless communication unit (Wifi, Bluetooth etc.)

provided on the connection member (6).

In a preferred embodiment of the invention, connection member (6) is used as connection point providing connection of shutter test device (1) to detector and tubes in fire extinguishing system to receive data.

The alarm detection and measurement circuit (7) of the invention measures the time period in which tubes are activated upon alarm response. Activation of tubes is the discharge of gas therein in line with the received signal as a result of fire detection. The signal is transmitted to the test device (1) via cable or wireless.

Operating principle of the test device (1) is as follows: shutter driver circuit (12) is activated by triggering mechanism (3) alerted by audio or physical interaction and the shutter (1) opens and passage of IR and UV light sources (8, 10) located behind it through obstacle and preferably passed through CaF2 glass (14) and reach the detectors. Upon activation of the triggering mechanism (3), the control unit takes the shutter (11) opening time as starting point and starts to receive data from detectors and tubes where connected. These data contain the information of the time period in which the detectors response to the radiations obtained by alarm detecting and measurement circuit (7) in the control unit and sent to light sources and the response to said radiations by detectors and the time in which tubes are activated. The said data are of the capability to detect millisecond periods and calculates the time period in milliseconds in which detectors detect the radiation dispersed upon opening of shutter (11) by alarm detection and measurement circuit (7), and the time in milliseconds in which tubes are activated. By means of such calculations it is tested whether detectors run or run in the intended level, and detectors are put into maintenance or continued to be used according to data read in LCD screen (4).

I claim:

1. A test device controlling whether fire extinguishing system comprising fire extinguishing tubes and detectors detecting flame spectrum generated UV and IR wavelengths function, and for determining the time period in which they take action and comprises:
an IR light source and/or a UV light source making radiation at different wavelengths that can be detected by sensors in the detectors to be tested and having flame spectrum;
a shutter located in a front part of said light sources, which controls reach of radiations of light sources to detectors by opening and closing;
a control unit receiving an alarm signal generated by detectors perceiving sent rays, finding out response time period of fire tubes activated as a result of alarm signal, calculating the time period in which fire extinguishing system work subject to said alarm and activation periods and controlling the shutter;
a communication unit performing data exchange among the detector, fire tube and control unit; and
a triggering mechanism activating/deactivating the control unit, bringing the shutter to the open/close position.

2. The test device according to claim 1, characterized by comprising:
a screen located on the device box and receiving and displaying data generated by the control unit.

3. The test device according to claim 1, characterized by comprising:
a glass located on the front lid and providing delivery of radiations passing therethrough to detector without dispersion.

4. The test device according to claim 3, characterized that the glass is CaF2.

5. The test device according to claim 1, characterized that the triggering mechanism is a button.

6. The test device according to claim 1, characterized in that the communication unit is wireless communication unit and/or connection cable inserted to the connection member located on device box and to detector and tube.

7. The test device according to claim 1, characterized that control unit comprises:
an alarm detection and measurement circuit measuring the time period in which detector detects the radiation delivered to it from light sources and gives alarms and the time period in which the tubes activated response; and
a shutter driver circuit controlling open/close position of shutter upon triggering by triggering mechanism.
